(19) United States
(12) Patent Application Publication
(10) Pub. No.: US 2017/0270210 A1
(43) Pub. Date: Sep. 21, 2017

(54) Data Infrastructure and Method for Ingesting and Updating A Continuously Evolving Social Network

(71) Applicant: Sysomos L.P., Toronto (CA)

(72) Inventors: Kanchana PADMANABHAN, Toronto (CA); Edward Dong-Jin KIM, Toronto (CA)

(73) Assignee: Sysomos L.P., Toronto (CA)

(21) Appl. No.: 15/444,998

(22) Filed: Feb. 28, 2017

Related U.S. Application Data
(60) Provisional application No. 62/309,037, filed on Mar. 16, 2016.

(51) Int. Cl. G06F 17/30

(52) U.S. Cl. CPC G06F 17/30867; G06F 17/30958; G06Q 50/01

(57) ABSTRACT

Data infrastructure systems and methods are provided for updating a continuously evolving social network. The social network is representable by a social network graph. A client application and graph data are retrieved from a database that stores the social network graph, in order to determine current activity in the social network. The current activity is used to determine one or more priority nodes in the social network graph to be updated. Social network updates are obtained for each of the one or more priority nodes. The one or more priority nodes in the social network graph are updated using the social network updates.

### CROSS-REFERENCE TO RELATED APPLICATIONS

This application claims priority to U.S. Provisional Patent Application No. 62/309,037 filed on Mar. 16, 2016, entitled “Data Infrastructure and Method for Ingesting and Updating a Continuously Evolving Social Network” and the entire contents of which is incorporated herein by reference.

### TECHNICAL FIELD

The following relates to systems and methods for ingesting and updating a continuously evolving social network.

### DESCRIPTION OF THE RELATED ART

In recent years social media has become a popular way for individuals and consumers to interact online (e.g. on the Internet). Social media also affects the way businesses aim to interact with their customers, fans, and potential customers online.

Some users on particular topics with a wide following are identified and are used to endorse or sponsor specific products. For example, advertisement space on a popular blogger's website is used to advertise related products and services.

Social network platforms are known to be used to communicate with a targeted group of people, or advertise to a targeted group of people. Examples of social network platforms include those known by the trade names Facebook, Twitter, LinkedIn, Tumblr, and Pinterest. Such social network platforms are also used to influence groups of people. Quickly identifying relevant target groups and/or popular or influential individuals becomes more difficult when the number of users within a social network grows. Furthermore, accurately identifying influential individuals within a particular topic can be difficult.

Massive social networks, such as Facebook, Twitter, and Instagram, include billions of users (e.g. data nodes) and trillions of edges (e.g. data links) representing interactions, dictating opinions, and causing viral explosions. Mining the network structure to achieve the above objectives can become more and more difficult as the networks continue to grow and change.

### SUMMARY

Below are example embodiments and example aspects of the data infrastructure system and methods for updating a continuously evolving social network. These example embodiments and aspects are non-limiting. Alternative embodiments or additional details, or both, are provided in the accompanying figures and the below detailed description.

In a general example embodiment, a method is provided for updating a social network graph, the method comprising: using at least one client application and graph data retrieved from a database storing the social network graph to determine current activity in the social network; using the current activity to determine one or more priority nodes in the social network graph to be updated; obtaining social network updates for each of the one or more priority nodes; and updating the one or more priority nodes using the social network updates.

In an example aspect, the method further includes adding the one or more priority nodes to a queue and updating each priority node upon determining the corresponding social network updates.

In another example aspect, the method further includes accessing the database to retrieve the current activity.

In another example aspect, the method further includes using at least one social network API to obtain the social network updates.

In another example aspect, the method further includes accessing the updated graph for performing at least one social media intelligence operation.

In another example aspect, the updating includes removing each priority node and re-establishing edges connected to that node based on the social network updates.

In another example aspect, the method further includes identifying at least one supernode in the one or more priority nodes.

In another example aspect, the method further includes, for each supernode: translating the supernode into a plurality of node objects; applying an identifier to each node object; and applying a predetermined formula to connect node objects by edges determined from the social network updates.

In another example aspect, the predetermined formula utilizes a set of 256 node objects.

In another general example embodiment, a computing system is provided for updating a social network graph, the computing system comprising a cluster of database servers storing a social network graph distributed across the cluster, the social network graph comprising user accounts represented as nodes connected to each other with edges. The computing system further comprises one or more servers comprising a processor, a memory, and a communication device, the communication device configured to receive and transmit data from the cluster. The memory comprises computer executable instructions to at least: access the cluster to obtain current activity associated with the user accounts in the social network graph; use the current activity to determine one or more priority nodes in the social network graph; store the one or more priority nodes on a queue within the memory; access the queue in the memory to identify a given node of the one or more priority nodes and obtain social network updates for the given node via an application programming interface also stored in the memory; use the social network updates to update the given node and its edge connections; and send the updated given node and the updated edge connections to the cluster via the communication device.

### BRIEF DESCRIPTION OF THE DRAWINGS

Embodiments will now be described by way of example only with reference to the appended drawings wherein:

FIG. 1 is a schematic diagram illustrating a continuous social network graph updating process;

FIG. 2 is a schematic diagram of a data infrastructure for ingesting, indexing and querying social network graph data;

FIG. 3 is a schematic block diagram illustrating further detail of an example aspect of the data infrastructure for retrieving and processing social network graph data to identify priority nodes in the graph;

FIG. 4 is a schematic block diagram of an example of a configuration for a social network intelligence system and a computing device connectable to a communication network;

FIG. 5 is a flow diagram illustrating example computer executable instructions for continuously updating a social network graph;

FIG. 6 is a graph illustrating a Twitter follower-count distribution;

FIG. 7 is a chart illustrating example Twitter supernodes;

FIG. 8 is a flow diagram illustrating example computer executable instructions for partitioning a supernode;

FIG. 9(a) is a flow diagram illustrating example computer executable instructions for determining influencers associated with a topic;

FIG. 9(b) is a flow diagram illustrating another set of example computer executable instructions for determining influencers associated with a topic;

FIG. 10 is a flow diagram illustrating example computer executable instructions for identifying and providing community clusters from each topic network; and

FIG. 11 is a flow diagram illustrating example computer executable instructions for identifying a target audience.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Providing computing structures and the corresponding computations for ingesting, storing, and indexing a data graph of over one trillion edges are significant technical challenges but it is further herein recognized that an even bigger technical challenge is to keep the data graph up-to-date. Social networks evolve with time (e.g., people make new friends, new users join the network, existing users unfriend others, etc.), and this means that data has to be constantly updated in order to be in sync with the social network (e.g., Twitter, Facebook, etc.). Obsolete networks can lead to incorrect computations, possibly impacting the transfer of data through the network and the analysis of the overall network (e.g. also sometimes called “big data”).

In the following computing system, the data that is to be persisted, indexed and queried corresponds to a social network where data nodes represent user accounts, and data edges represent relationships (e.g., re-tweets, shares, friends, followers, etc.). It is recognized that social networks evolve with time. For example, there are new users, new relationships being formed, relationships being un-formed, and users deleting their accounts. Therefore, yesterday's data network may look very different from today's network, and data typically becomes obsolete quickly.

Obsolete data is considered to be ineffective at the application level, no matter how efficiently it is stored and indexed at the hardware level. As such, it has been found that particular attention should be made to providing a data infrastructure and computer implemented mechanism for the infrastructure that updates stored data in these social networks at regular intervals in a way that utilized hardware resources more efficiently.

In general, keeping the social network graph data updated in a way that effectively utilizes hardware resources, involves addressing three computing challenges, namely identifying which of the data should be updated, where to get the updates (e.g. which data sources to access and what data types to extract), and the manner in which the updates are made (e.g. what computations are used to make the updates).

With respect to the data that should be updated, one should update the data that is most useful in the immediate future. As described herein, it has been found that client applications that determine important or influential users, herein after “priority nodes” (or priority users) generate results that can be leveraged to determine the priority nodes that should be updated more frequently. Examples of such client applications include those for determining influencers (e.g. user accounts that are considered influential in a social data network), determining look-a-likes, generating re-Tweet trees, determining communities (e.g. user accounts that are having important conversations in a social network), etc.

The results surfaced by these applications can then be used to choose users who need to be updated at that time in a continuous updating process. In this way, the computing system hardware can avoid the time consuming and computationally costly process of updating the entire social network graph. It will be appreciated that a computing system may initially take several months to execute the computations to build an entire social network graph.

With respect to getting updates, it is herein recognized that the best place to obtain updates is normally dependent on the data. When the follower/friend relationships need updates, various available social media network APIs (application programming interfaces) can be used, for example, to extract activity relationships such as re-Tweet or re-blog activities, as the social media feeds are ingested into a computing system that is configured to monitor and process such data.

Regarding how to update, as will be explained in greater detail below, the aforementioned client applications (e.g. ones to identify “influencers”) can produce the priority nodes (users) rapidly, however, it is recognized that writing updates for these nodes, to the social network graph database, should be planned carefully in order to effectively utilize the available hardware and software resources. For example the updates should happen without impacting the computational read operations that are currently happening. To address this consideration, asynchronous updates can be used, where an intermediary electronic data storage is used to handle the difference in production and consumption rates.

A system and methodology are herein described, which provide a computationally efficient and near-real-time method for ingesting, persisting and indexing the edges/links of massive online social data networks. This enables powerful data science driven applications such as the Sysomos Optimize for Ads (for determining look-a-likes), Sysomos Influence (for determining top influencers and influencer communities), Sysomos MAP (for virality visualization in retweet trees), etc.

Social networking platforms include users who generate and post content for others to see, hear, etc. (e.g. via a network of computing devices communicating through websites associated with the social networking platform). Non-limiting examples of social networking platforms are Facebook, Twitter, LinkedIn, Pinterest, Tumblr, blogospheres, websites, collaborative wikis, online newsgroups, online forums, emails, and instant messaging services. Currently known and future known social networking platforms may be used with principles described herein. Social networking platforms can be used to market to, and advertise to, users of the platforms. Although the principles described herein may apply to different social networking platforms, many of the examples are described with respect to Twitter to aid in the explanation of the principles.

More generally, social networks allow users to easily pass on information to all their followers (e.g., re-tweet or @reply using Twitter) or friends (e.g., share using Facebook).

The terms “friend” and “follower” are defined below.

The term “follower”, as used herein, refers to a first user account (e.g. the first user account associated with one or more social networking platforms accessed via a computing device) that follows a second user account (e.g. the second user account associated with at least one of the social networking platforms of the first user account and accessed via a computing device), such that content posted by the second user account is published for the first user account to read, consume, etc. For example, when a first user follows a second user, the first user (i.e. the follower) will receive content posted by the second user. In some cases, a follower engages with the content posted by the other user (e.g., by sharing or reposting the content). The second user account is the “followee” and the follower follows the followee.

It will be appreciated that a user account is a known term in the art of computing. In some cases, although not necessarily, a user account is associated with an email address. A user has a user account and is identified to the computing system by a username (or user name). Other terms for username include login name, screen name (or screenname), nickname (or nick) and handle.

A “friend”, as used herein, is used interchangeably with a “followee”. In other words, a friend refers to a user account, for which another user account can follow. Put another way, a follower follows a friend.

A “social data network” or “social network”, as used herein includes one or more social data networks based on different social networking platforms. For example, a social network based on a first social networking platform and a social network based on a second social networking platform may be combined to generate a combined social data network. A target audience of users may be identified using the combined social data network, or also simply herein referred to as a “social data network” or “social network”.

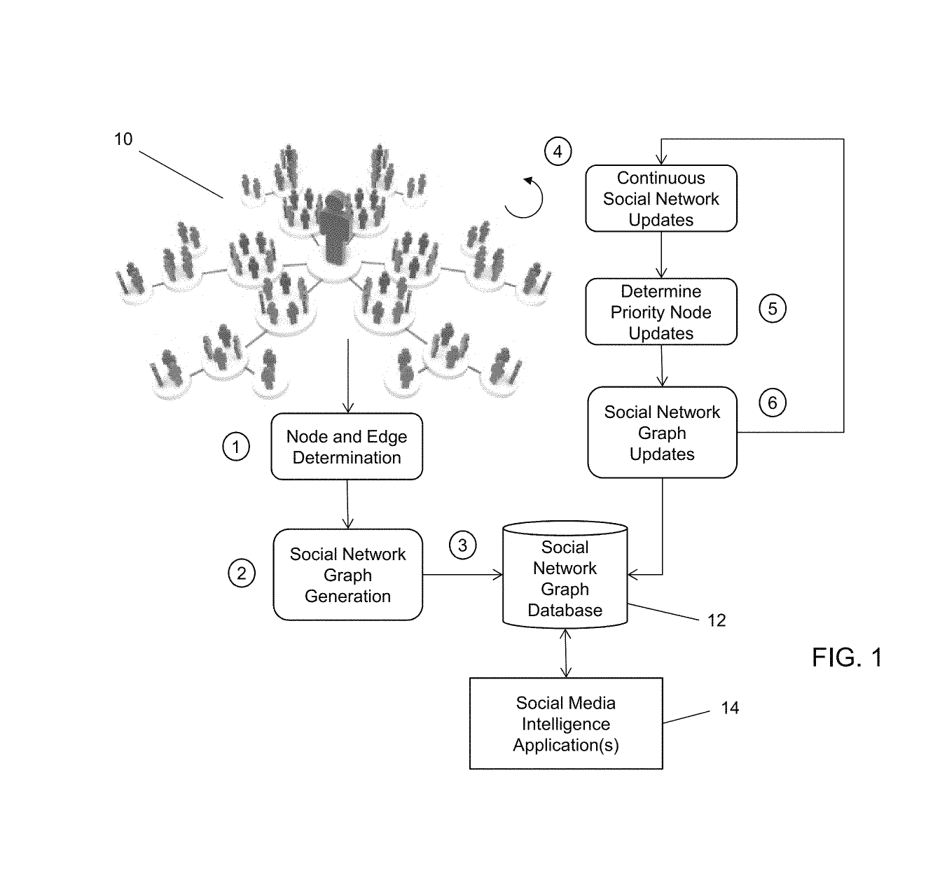

Turning now to the figures, FIG. 1 illustrates an example of a process that can be implemented for continuously updating a social network graph, as the social network itself continuously evolves. An example of a social data network 10 is shown pictorially for illustrative purposes, however, it can be appreciated that multiple social data networks 10 can also be analyzed and updated accordingly using the principles discussed herein. The social data network 10 has associated with it social network data, which includes, among other things, node and edge data that defines users/accounts (nodes), and relationships between users/accounts (edges) as discussed above. The node and edge information can be obtained by analyzing the social data network 10 in stage 1 to generate a social network graph at stage 2. Typically the generation of the social network graph (i.e. stages 1 and 2) takes a significant amount of time, due to the vast amount of data that is required to be processed. The generated social network graph is then stored in a social network graph database 12 at stage 3, enabling social media intelligence applications 14 to analyze the graph and its data for various purposes, e.g., for targeted advertising, etc.

Due to the sheer volume of data represented by the social network graph, and the time and computing resources it would take to update the social network graph, it typically becomes infeasible to continuously update the entire graph. For example, to build a social graph for a large social data network (e.g. Twitter) a processor or set of processors can take months to perform the computations. It is herein recognized that rebuilding an updated social graph in the same approach is technically problematic.

In the presently described system, the social network graph is continuously updated by targeting specific important and/or influential users/nodes (i.e. “priority nodes”) and only updating those priority nodes at any given iteration of the updating process in order to effectively utilize the available software and hardware resources while keeping the graph up to date. In FIG. 1, social network updates are continuously determined by analyzing the social data network 10 and how it is changing at stage 4. Various client applications can be used to determine which nodes should be prioritized at stage 5, and the social network graph is updated in stage 6 by replacing the previous node and relationships with fresh information and data. The updating stages 4-6 shown in FIG. 1 can be continuously performed over time to keep the social network graph up-to-date.

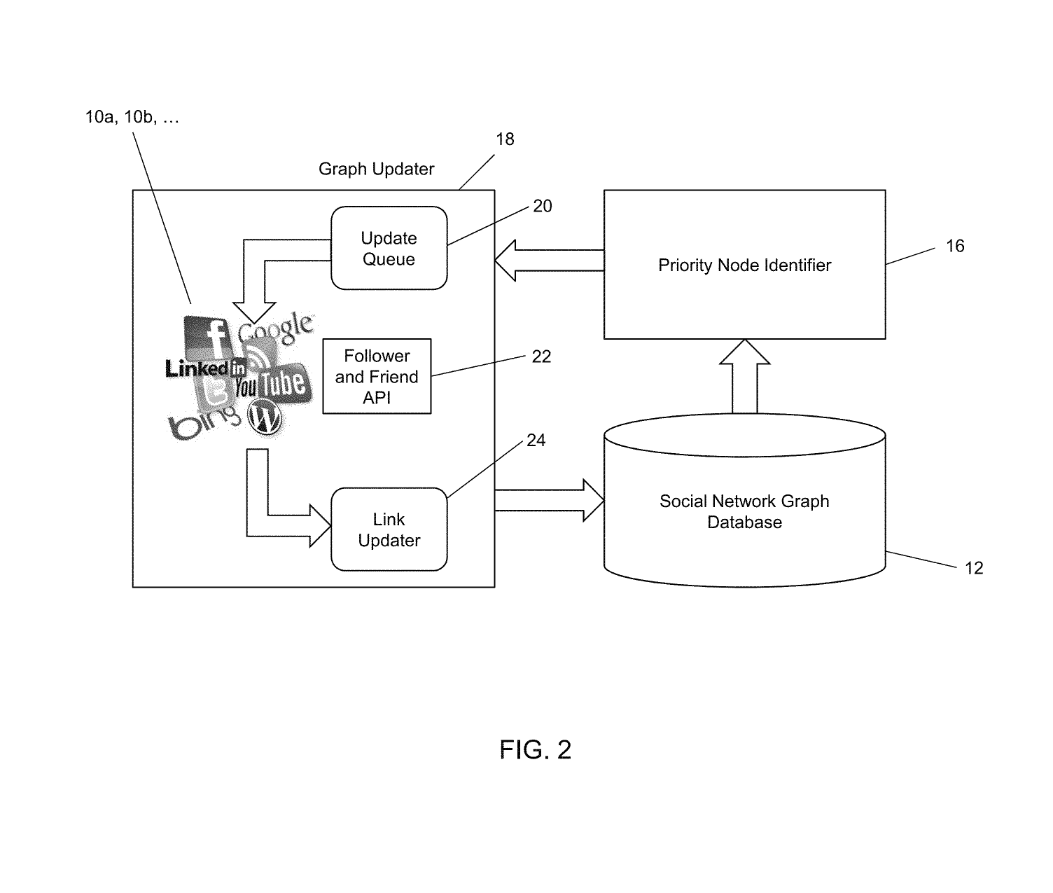

FIG. 2 illustrates a data infrastructure that can be implemented for updating the social network graph database 12. In this example, a priority node identifier 16 is used to analyze the current social network graph to determine important, influential or otherwise “priority” nodes. As used herein, a “node” may represent an individual user, group, entity, organization, etc. that has a social network account and can follow, be followed, can re-Tweet, etc. The priority node identifier 16 in FIG. 2 generally represents any one or more client applications or client systems that are utilized to surface results that can be used to choose nodes that should be updated. A graph updater 18 is also shown, which utilizes the determined priority nodes to target those portions of the social network graph in order to efficiently update the graph. The graph updater 18 includes, or has access to, a memory device storing an update queue 20, which is used as an intermediary storage and allows a priority assignment for each node added to the queue. The priority can be used to determine the order in which the nodes are processed by the graph updater 18. An example implementation of the update queue 20 is available under the trade names ActiveMQ, RabbitMQ, and Kaftka.

It is also recognized that the memory device storing the update queue 20 has a finite memory storage size, which can cause technical problems when queuing nodes to be updated. In other words, the number of nodes that are being queued in the memory device may potentially exceed the memory storage size. However, the system provided herein identifies important nodes, via the priority node identifier 16, that should be updated. This reduces the number of nodes being stored in the memory device for the update queue 20.

When processing the nodes in the queue, the graph updater 18 uses a link updater 24 to obtain the update data, by accessing various follower and friend APIs 22 to obtain the relevant social network information. The link updater 24 reads nodes from the update queue 20, queries the social network's API, and updates the databases using the database-specific API. By prioritizing via the queue, the link updater 24 can continuously update the social network graph database 12 as new priority nodes are continuously identified by the priority node identifier 16, in a computationally and hardware/memory resource efficient manner. Preferably, the link updater 24 runs continuously with periodic “sleep” times, e.g., during peak usage hours.

It will be appreciated that the graph updater 18 advantageously does not need to receive and store a complete copy of the social network data, which saves bandwidth resources and memory resources. Instead, the graph updater 18 crawls and extracts features via the API 22.

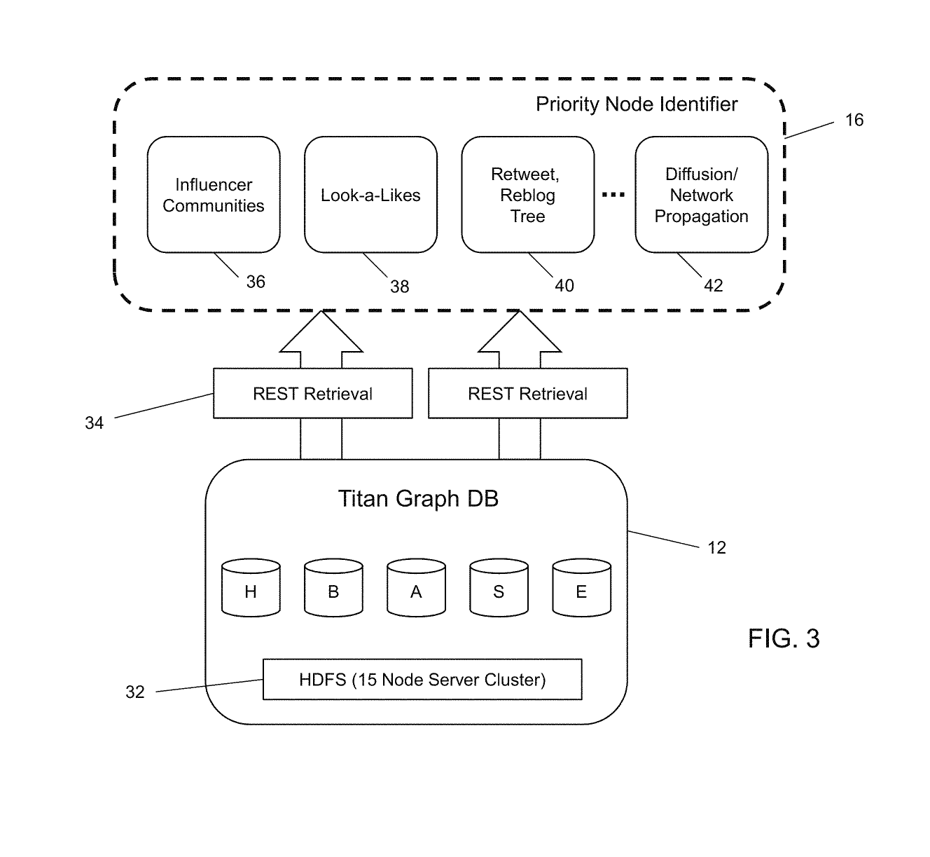

FIG. 3 illustrates an example of an implementation for retrieving graph data and analyzing same using the priority node identifier 16. In this example implementation, an HBASE distributed Titan Graph database 12 runs on top of a Hadoop Distributed File System (HDFS) 32 to store the social network graph (e.g., in a 15 node server cluster configuration). One or more representational state transfer (REST) retrieval modules 34 are used to retrieve data from the database 12 and feed one or more client applications running in or as the priority node identifier 16. Some non-limiting example client applications shown in FIG. 3 are an influence communities module 36, a look-a-likes module 38, a Re-Tweet, Reblog Tree module 40, a diffusion/network propagation module 42, etc. As noted above, these client applications can be used to determine influential, important or otherwise “priority” nodes to update at a particular updating iteration.

The HDFS 32 in this example is chosen to address size and scale considerations. For instance, the 1+ trillion-edge network with nodes (users) and interconnections/edges (properties) need to be stored. Moreover, there is no upper limit to the size of this network. For example, popular social media networks are known to add hundreds of thousands of users per day and the number of total social media users has steadily risen, with tens or hundreds of million new users added on an annual basis. These statistics make it difficult if not impossible to put a cap on the expected size of the network, unless one is to unrealistically account for all humans on earth. In some cases, even this might not suffice since one person can and does have multiple accounts.

To address this, the illustrated implementation uses a distributed storage cluster like HDFS 32 that is built for future scaling. HDFS 12 is open source and can work with commodity hardware. It provides data reliability as it provides triple replication of data. It also has high availability, that is, a large number of machines in the cluster need to be unavailable for the data to be irretrievable. It also provides high bandwidth to support MapReduce workloads, which enables fast parallel computations. MapReduce is a computing implementation for processing and generating large data sets with a parallel, distributed computing on a cluster. It also allows for massive scalability across many (e.g. hundreds or thousands) of servers in a cluster.

It can be appreciated that data storage is an important dimension but often not the only prerogative. Structure of the data is an important feature that can enable a plethora of applications. Given a HDFS persistence, one proposed solution would be to organize the social network data as files and put a SQL-like index (like HIVE) interface over the files. Such a solution would be suitable to retrieve the data.

Social network data maps to a data structure referred to as Graph. Storing the social network in its true graph form can enable an interested party to answer interesting questions such as “Who is the most influential person in the social graph?” Here, “influential” does not simply refer to a person who has the most followers, but refers to a person who can cause a viral effect (e.g., Page Rank on entire graph).

A solution that is optimized for all the benefits offered by HDFS 32 is the Titan Graph database 12 that uses HBASE/Cassandra as the underlying data store. The Titan Graph 12, HBASE, and HDFS 32 interplay can be seen in FIG. 3. HBASE offers the additional benefit of being a general Key-Value store for massive datasets.

Titan Graph stores node and edge data and can potentially store and index any number of properties on the node. It also gives the added benefit of auto-computing the reciprocal relationship; e.g., if we store that A is a follower of B then the Titan API can conclude that B is followed by A. The query is based on the Gremlin language that can be used to make graph queries such as “How many followers in total do the followers of Celebrity A have?” This question can estimate the number of people who will get a message from Celebrity A provided all of his followers re-tweeted his message.

Faunus is a Hadoop-based graph analytics engine for analyzing graphs stored in a Titan Graph database 12. Faunus can run graph algorithms like Depth/Breadth First Search, PageRank (the viral effect of a user) and Low-Rank Patterns (ordering friends by the number of common friends) in parallel. Faunus can also assist with bulk loads into the Titan database 12.

Rexster is a suitable REST-based server that exposes Titan Graph in a service oriented architecture (SOA). Rexster provides a fast near-real time retrieval system for the graph data along with a non-cumbersome method of querying the graph. The HTTP web service provides standard low-level GET, POST, PUT, and DELETE methods. The service-oriented architecture of Rexster with Titan facilitates use from many applications. REST endpoints can be written in Gremlin query language, which is a superset of Java. Gremlin with Titan API allows a computing system to process more complex graph problems, including a custom built “induced graph”: query; e.g., given the nodes A, B, and C, who follows whom.

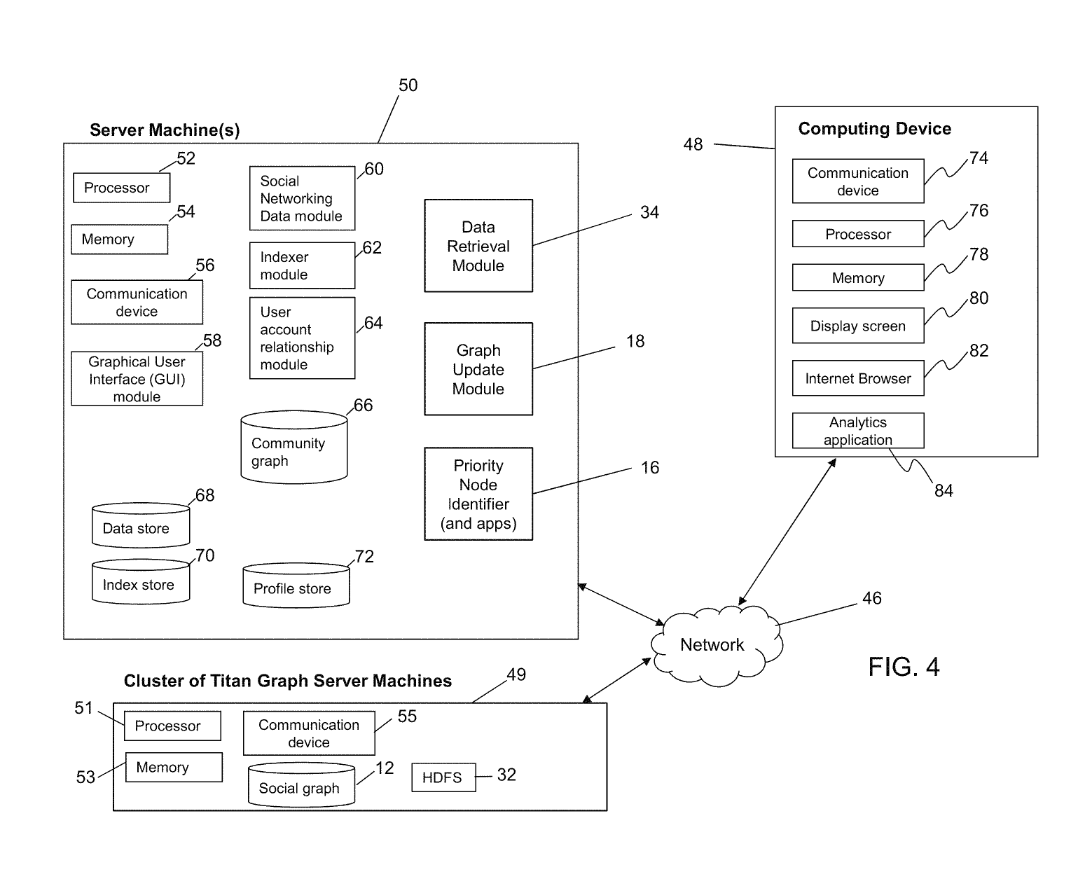

Turning to FIG. 4, a schematic diagram of a computing system is shown. A server machine 50, also called a server, is in communication with a computing device 48 over a data network 46. The server 50 obtains and analyzes social network data and provides results to the computing device 48 over the network 46. The computing device 48 can receive user inputs through a GUI to control parameters for performing or reviewing an analysis.

It can be appreciated that social network data includes data about the users of the social network platform, as well as the content generated or organized, or both, by the users. Non-limiting examples of social network data includes the user account ID or user name, a description of the user or user account, the messages or other data posted by the user, connections between the user and other users, location information, etc. An example of connections is a “user list”, also herein called “list”, which includes a name of the list, a description of the list, and one or more other users which the given user follows. The user list is, for example, created by the given user.

The server 50 includes a processor 52 and a memory device 54. In an example embodiment, the server 50 includes one or more processors and a large amount of memory capacity. In another example embodiment, the memory device 54 or memory devices are solid state drives for increased read/write performance. In another example embodiment, multiple servers are used to implement the methods described herein. In other words, in an example embodiment, the server 50 refers to a server system. In another example embodiment, other currently known computing hardware or future known computing hardware is used, or both.

The server 50 also includes a communication device 56 to communicate via the network 46. The network 46 may be a wired or wireless network, or both. In an example embodiment, the server 50 also includes a GUI module 56 for displaying and receiving data via the computing device 48. The server 50 also includes: a social networking data module 60, an indexer module 62, and a user account relationship module 64. Other components or modules may also be utilized by or included in the server 50 even if not shown in this illustrative example. Similarly, other functionality can be implemented by the modules shown in FIG. 4.

The server 50 also includes a number of databases, including a data store 68, an index store 70, a profile store 72, and a database for storing community graph information 66.

The social networking data module 60 is used to receive a stream of social networking data. In an example embodiment, millions of new messages are delivered to social networking data module 60 each day, and in real-time. The social networking data received by the social networking data module 60 is stored in the data store 68.

In an example embodiment, only certain types of data are received based on the follower and friend API 22, such as node and edge connection data. In other words, the message content may or may not be received and stored by the server 50.

The indexer module 62 performs an indexer process on the data in the data store 68 and stores the indexed data in the index store 70. In an example embodiment, the indexed data in the index store 70 can be more easily searched, and the identifiers in the index store can be used to retrieve the actual data (e.g. full messages).

A social network graph is also obtained from the social networking platform server, not shown, and is stored in the social network graph database 12. The social network graph, when given a user as an input to a query, can be used to return all users “following” the queried user.

The profile store 72 stores meta data related to user profiles. Examples of profile related meta data include the aggregate number of followers of a given user, self-disclosed personal information of the given user, location information of the given user, etc. The data in the profile store 72 can be queried.

In an example embodiment, the user account relationship module 64 can use the social network graph 12 and the profile store 72 to determine which users are following a particular user. In other words, a user can be identified as “friend” or “follower”, or both, with respect to one or more other users. The module 64 may also configured to determine relationships between user accounts, including reply relationships, mention relationships, and re-post relationships.

The server 50 may also include a community identification module or capability (not shown) that is configured to identify communities (e.g. a cluster of information within a queried topic such as Topic A) within a topic network. The output from a community identification module comprises a visual identification of clusters (e.g. visually coded) defined as communities of the topic network that contain common characteristics and/or are affected (e.g. influenced such as follower-followee relationships), to a higher degree by other entities (e.g. influencers, experts, high-authority users) in the same community than those in another community.

The server 50 in this example also includes a data retrieval module 34 (e.g., REST module), the graph update module 18, and the priority node identifier 16 (with one or more client applications running therewith, or thereon).

The server 50 is in communication with a cluster of titan graph server machines 49, which has memory devices 53 that store the social graph 12 and the HDFS 32. Each server machine in the titan graph cluster 49 includes a processor 51 and a communication device 55 for indexing and storing the data. Using the communication devices, the server 50 and the cluster of titan graph server machines 49 communicate with each other over the data network 46. While a previous example embodiment described a cluster of 15 server nodes, it will be appreciated that different numbers of server nodes may be used to form the cluster.

The computing device 48 includes a communication device 74 to communicate with the server 50 via the network 46, a processor 76, a memory device 78, a display screen 80, and an Internet browser 82. In an example embodiment, the GUI provided by the server 50 is displayed by the computing device 48 through the Internet browser 82. In another example embodiment, where an analytics application 84 is available on the computing device 48, the GUI is displayed by the computing device through the analytics application 84. It can be appreciated that the display screen 80 may be part of the computing device 48 (e.g. as with a mobile device, a tablet, a laptop, a wearable computing device, etc.) or may be separate from the computing device (e.g. as with a desktop computer, or the like).

Although not shown, various user input devices (e.g. touch screen, roller ball, optical mouse, buttons, keyboard, microphone, etc.) can be used to facilitate interaction between the user and the computing device 48.

It will be appreciated that, in another example embodiment, the system includes multiple server machines. In another example embodiment, there are multiple computing devices that communicate with the one or more servers.

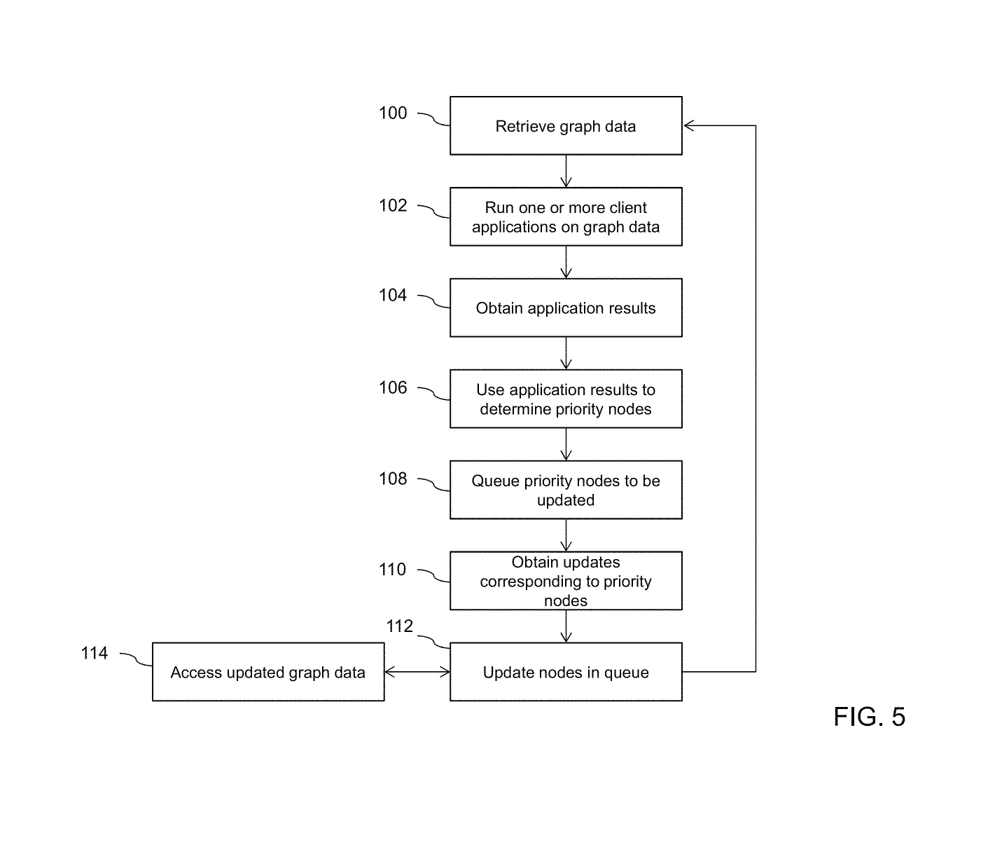

FIG. 5 illustrates an example set of computer executable operations for updating a social network graph database 12. At step 100 the REST module 34 is used to retrieve the graph data from the database 12 for the priority node identifier 16. The priority node identifier 16 runs one or more client applications at step 102 using the retrieved graph data to obtain the application results at step 104. The application results are used at step 106 to determine the “priority” nodes to be updated in the social network graph. The graph update module 18 queues the nodes to be updated at step 108 using the update queue 20, and obtains updated social network data for the priority nodes by running the link updater 24 to access the data via the follower and friend API(s) 22 at step 110. The priority nodes in the queue are updated at step 112 to effectively perform an updating operation on the social network graph without having to process and update the entire graph. This allows updated graph data to be accessed at step 114, e.g., by social media intelligence applications 14. Each priority node is updated by effectively replacing that node and its previous edges, with an updated node and the new incident edges determined from the recent social network activity. For example, for non-supernodes that are not sharded (see discussion below), only the edges would be deleted and replaced with all new edges. That is, the node would not need to be replaced/created unless such a non-supernode from a previous update cycle has changed into a supernode in the current update cycle and a new supernode has been found in the current update cycle.

In updating the priority nodes at step 112, it is recognized that some of these nodes will, by virtue of their importance, have a disproportionately high number of edges, e.g., those with millions of followers. In graph theory a vertex with a disproportionately high number of incident edges is often referred to as a “supernode”. Theoretically, any graph database Titan/HBASE/Cassandra can ingest a supernode. However, in practice, writing a supernode to the graph would often fail due to the sheer skewed memory requirements of the data.

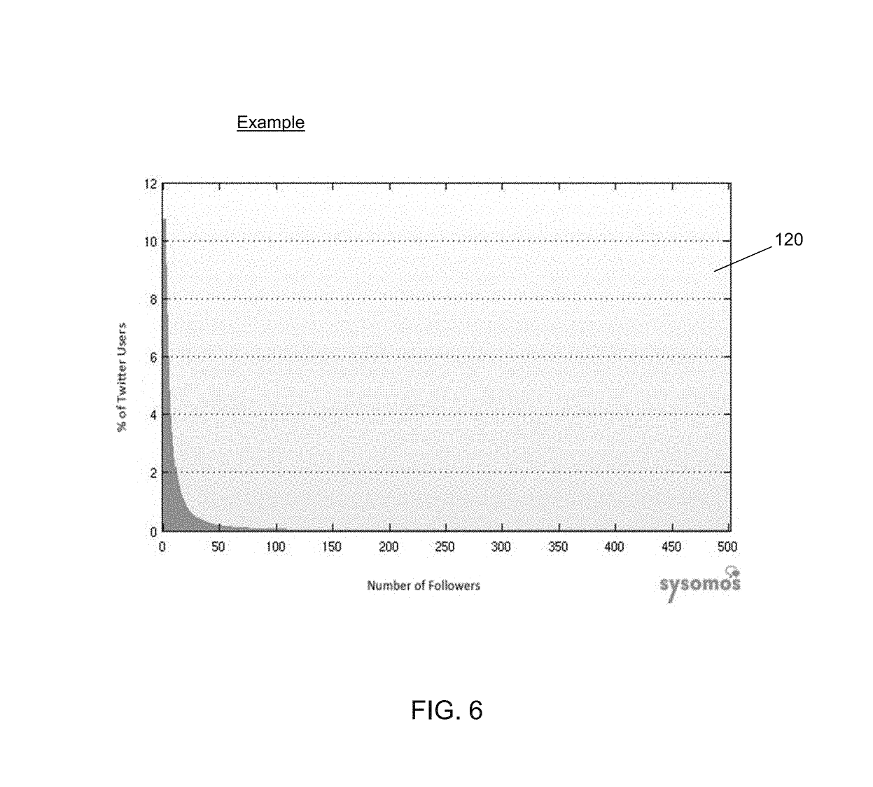

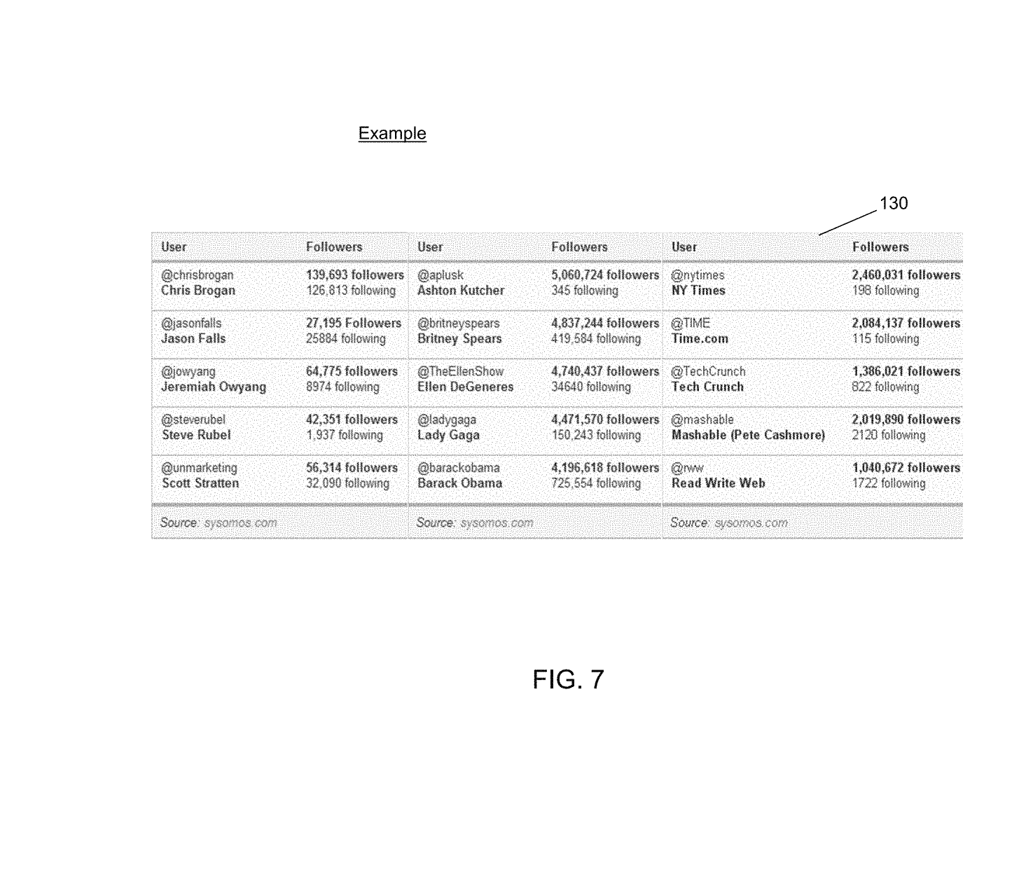

One solution would be to ignore those nodes since the follower distribution on social network graph is highly skewed as shown in the graph 120 in FIG. 6, e.g., there are only a few nodes with massive follower-counts. However, it is recognized that supernodes should not be ignored (see the table 130 in FIG. 7) in social media networks because the supernodes are also typically the most influential people on the network and hence key to any analysis.

To address the issues posed by the need to process supernodes, it has been found that “sharding,” i.e., partitioning very large datasets into smaller and more easily managed chunks called “data shards” can be performed. In an example embodiment, sharding of supernodes is done in a way such that:

(a) the applications can be ignorant of the sharding, and

(b) sharding is based on a formula (and not random paritions) and so the original complete dataset can be easily recreated.

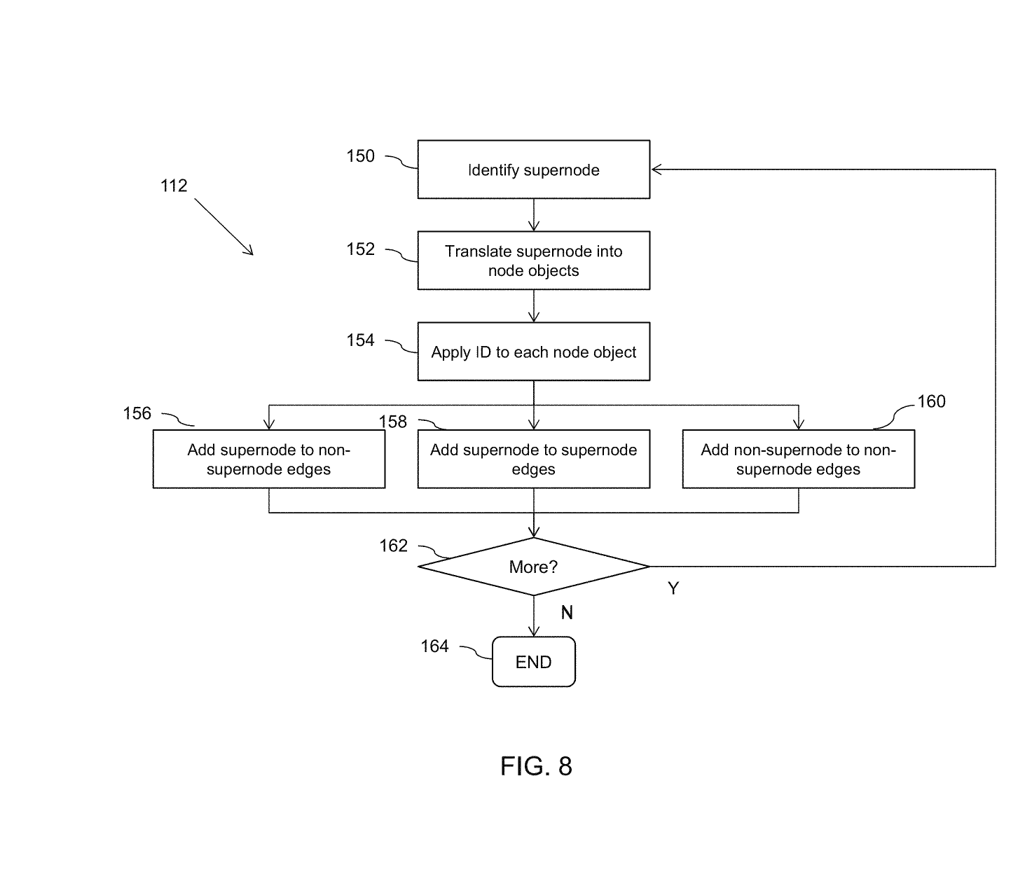

In another example embodiment, sharding allows storing/updating any/all supernodes and is independent of the number of supernodes at any given time in the network. Sharding can work for future supernodes as well, i.e., if a non-supernode today becomes a supernode tomorrow, the system would be able to ingest it without any issues. Sharding helps reduce computation when handling supernodes. Considering the problems identified above, namely users (nodes) with an extremely high number of edges, the induced graph can be found without having to process all of the data of each supernode. Instead, only the appropriate shards are processed by applying a sharding computing process such as that shown in FIG. 8. This process is data agnostic and should work as long as it can be connected to an endpoint to retrieve the data and another endpoint to write data to the database 12. It can also write to multiple data stores simultaneously. While the examples herein write to a Titan graph database 12, the system described herein can also write other formats to HBASE and SQL tables that serve different applications.

Turning now to FIG. 8, at step 150, the priority node identifier 16 or data update module 18 identifies a supernode, and at step 152 translates the supernode into a specific number of node objects according to a predetermined and repeatable formula that allows the sharded supernode to be reconstructed if so desired. For example, a computation illustrated herein may be referred to as rule “ID % 256”, in which as a first rule, every supernode translates into 256 node objects (e.g., a supernode with ID TT123 will have 256 sub-nodes in with IDs TT123P1, TT123P2, TT123P3 and so on). As such, at step 154 an identifier (ID) is applied to each of the node objects. It can be appreciated that various other mapping rules can be used and, in general, the mapping should enable the graph to be updated such that: 1) a supernode can be mapped to its sharded parts, and 2) a follower or friend of a supernode knows with which shard it is associated. This configuration enables the induced subgraph execution to be more efficiently performed. By induced subgraph, consider the following example. Given nodes A, B, and C, find the edges that exist between these three nodes. The induced subgraph will need access to followers/friends of A, B, and C and would need to determine if A and B are friends/followers of C, and likewise for the other nodes.

Processing of a sharded supernode is more computationally efficient as it can facilitate loading the data into the graph database, and querying.

For loading the data into the graph database, consider that node A is a supernode. When the system writes A into the database, three executions typically occur: a) the node A and nodes of all followers of A are created (if they do not already exist), b) node A is updated with all edges from its followers, and c) all the follower nodes are updated with information about node A. For example, if node A had 42 million followers (as has been found with at least some known supernodes), then 42 million nodes of the graph would get updated at the same time. Sharding enables this updating to be performed in smaller data chunks, which is more efficient for computing hardware.

For querying, an important question that is asked of a graph database is regarding the induced subgraphs. For example, given nodes A, B, and C, an example query is to return all edges that exist between A, B, and C. One way to implement such a query is to get all followers of A and check to see if B and C exist; and do the same for nodes B and C. If A was a supernode, and written without sharding, then 42 million nodes would need to be checked for equality with B and C. With sharding, however, the system can identify the shards of A where B and C could potentially exist and only process those shards.

For the edges, step 156 is performed to add supernode to supernode edges, step 158 is performed to add supernode to supernode edges 158, and step 160 is performed to add non-supernode to non-supernode edges. To illustrates the edge rules, the following example is provided using the formula “ID % 256”.

At step 156, if TT<id1> is a supernode (with 256 sub-nodes), and TT<id2> is a non-super node, and one wants to add a follower edge (either IN/OUT) between the two nodes, then TT<id2> is connected to TT<id1>P<id % 256>. For example, say TT<id2> is TT260, and TT<id1> is TT123, then, an edge would be created from TT123P4 (260% 256=4) to TT260.

At step 158, if TT<id1> is a supernode, and TT<id2> is a supernode, then connect TT<id1>P<id2% 256> to TT<id2>P<id1% 256>. For example, say id1==123 and id2==260. Then, an edge would be added from TT123P4 (260% 256=4) to TT260P123 (123% 256=123).

At step 160, for a non-supernode to non-supernode edge, simply connect the two edges.

The graph update module 18 determines at 162 if any more supernodes are to be sharded. If not, the process ends at 164. If so, the process is repeated by identifying the next supernode at step 150.

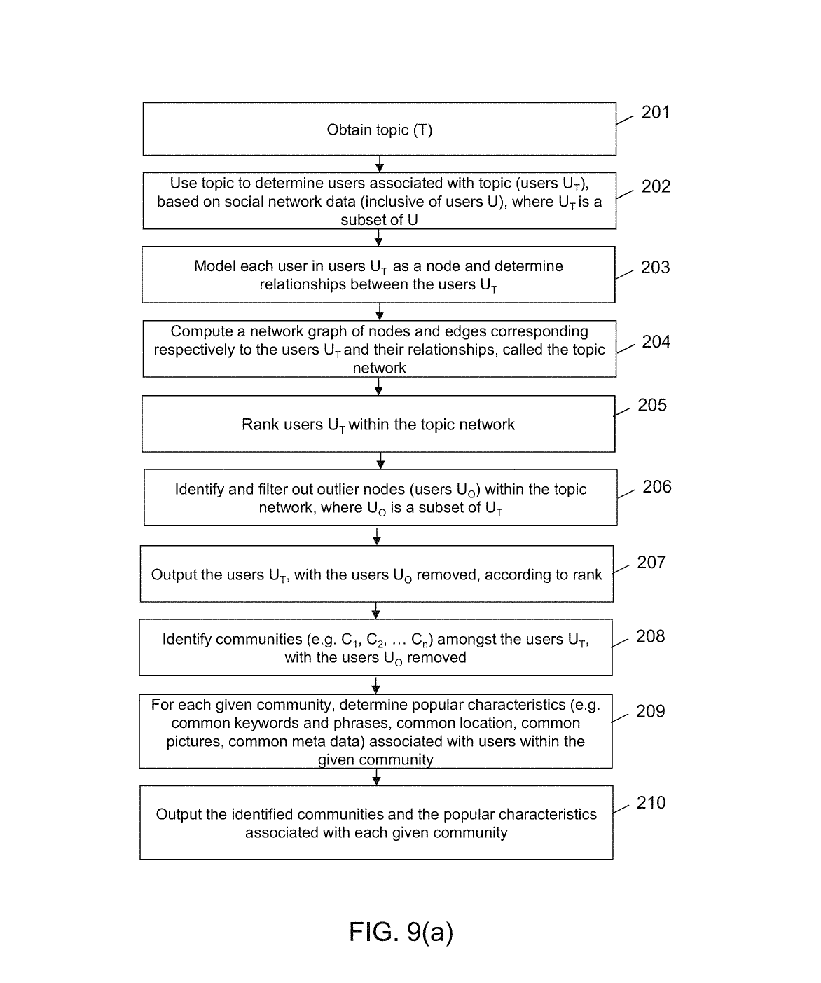

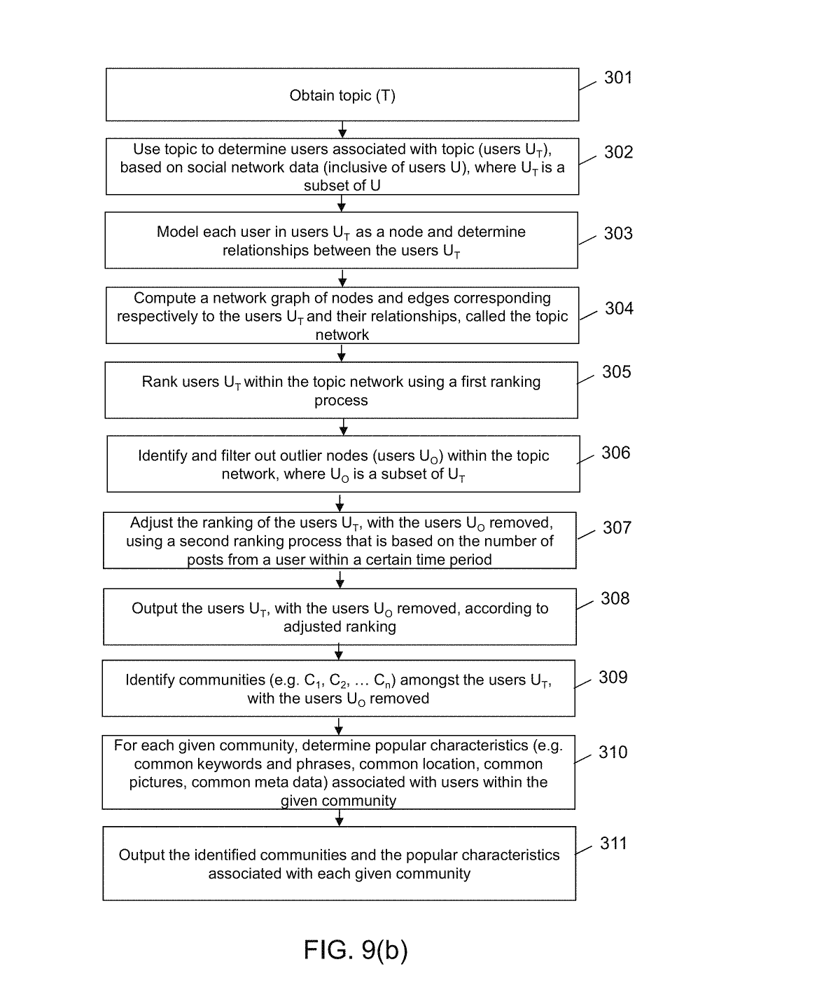

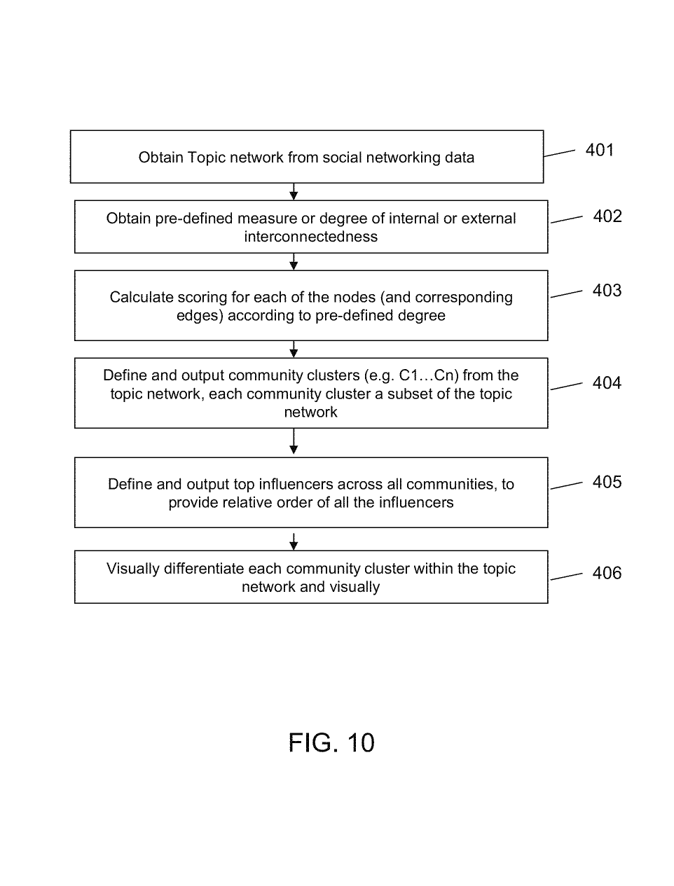

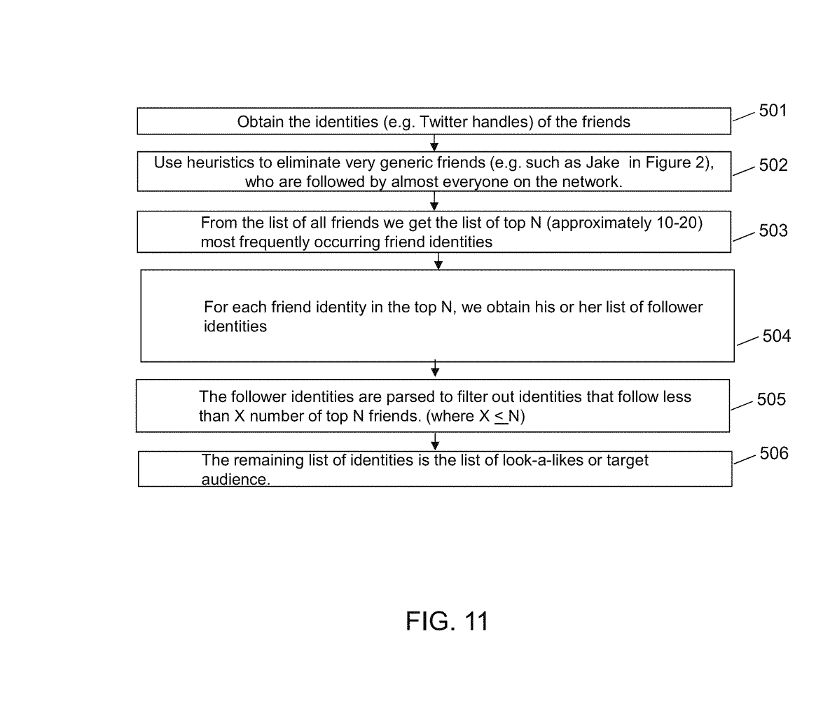

In order to determine which nodes should be updated at any given iteration (whether they are supernodes or non-supernodes), as indicated above, one or more client applications are run against the retrieved graph data (e.g., applications 36-42 shown in FIG. 3). The following provides some examples for determining influencers (e.g., using the influencer community module 36)—FIGS. 9(a), 9(b), and 10; and for determining target audiences—FIG. 11.

### Influencers

As used herein, the term “influencer” refers to a user account that primarily produces and shares content related to a topic and is considered to be influential to other users in the social data network. The term “follower”, as used herein, refers to a first user account (e.g. the first user account associated with one or more social networking platforms accessed via a computing device) that follows a second user account (e.g. the second user account associated with at least one of the social networking platforms of the first user account and accessed via a computing device), such that content posted by the second user account is published for the first user account to read, consume, etc. For example, when a first user follows a second user, the first user (i.e. the follower) will receive content posted by the second user. A user with an “interest” on a particular topic herein refers to a user account that follows a number of experts (e.g. associated with the social networking platform) in the particular topic. In some cases, a follower engages with the content posted by the other user (e.g. by sharing or reposting the content).

Identifying the key influencers is desirable for companies in order, for example, to target individuals who can potentially broadcast and endorse a brand's message. In the present example, influencer's can also be considered priority nodes to be updated in the database 12. The process of identifying influencers and their communities may be executed via the influencer communities module 36.

Turning to FIG. 9(a), an example embodiment of computer executable instructions are shown for determining one or more influencers of a given topic. The process shown in FIG. 9(a) assumes that social network data is available to the server 50, and the social network data includes multiple users that are represented as a set U. At block 201, the server 50 obtains a topic represented as T. For example, a user may enter in a topic via a GUI displayed at the computing device 48, and the computing device 48 sends the topic to the server 50. At block 202, the server 50 uses the topic to determine users from the social network data which are associated with the topic. This determination can be implemented in various ways and will be discussed in further detail below. The set of users associated with the topic is represented as U_{T}, where U_{T} is a subset of U.

Continuing with FIG. 9(a), the server 50 models each user in the set of users U_{T} as a node and determines the relationships between the users U_{T} (block 203). The server 50 computes a network of nodes and edges corresponding respectively to the users U_{T} and the relationships between the users U_{T} (block 204). In other words, the server creates a network graph of nodes and edges corresponding respectively to the users U_{T} and their relationships. The network graph is called the “topic network”. It can be appreciated that the principles of graph theory are applied here. The relationships that define the edges or connectedness between two entities or users U_{T} can include for example: friend connection and/or follower-followee connection between the two entities within a particular social networking platform. In an additional aspect, the relationships could include other types of relationships defining social media connectedness between two entities such as: friend of a friend connection. In yet another aspect, the relationship could include connectedness of a friend or follower connection across different social network platforms (e.g. Instagram and Facebook). In yet a further aspect, the relationship between the users U_{T} as defined by the edges can include for example: users connected via re-posts of messages by one user as originally posted by another user (e.g. re-tweets on Twitter), and/or users connected through replies to messages posted by one user and commented by another user via the social networking platform. Referring again to FIG. 9(a), the presence of an edge between two entities indicates the presence of at least one type of relationship or connectedness (e.g. friend or follower connectivity between two users) in one or more social networking platforms.

The server then ranks users within the topic network (block 205). For example, the server uses PageRank to measure importance of a user within the topic network and to rank the user based on the measure. Other non-limiting examples of ranking algorithms that can be used include: Eigenvector Centrality, Weighted Degree, Betweenness, Hub and Authority metrics.

The server identifies and filters out outlier nodes within the topic network (block 306). The outlier nodes are outlier users that are considered to be separate from a larger population or clusters of users in the topic network. The set of outlier users or nodes within the topic network is represented by U_{O}, where U_{O} is a subset of U_{T}. Further details about identifying and filtering the outlier nodes are described below.

At block 207, server outputs the users U_{T}, with the users U_{O} removed, according to rank.

In an alternate example embodiment, block 206 is performed before block 205.

At block 208, the server identifies communities (e.g. C₁, C₂, . . . , Cₙ amongst the users U_{T} with the users U₀ removed. The identification of the communities can depend on the degree of connectedness between nodes within one community as compared to nodes within another community. That is, a community is defined by entities or nodes having a higher degree of connectedness internally (e.g. with respect to other nodes in the same community) than with respect to entities external to the defined community. As will be defined, the value or threshold for the degree of connectedness used to separate one community from another can be pre-defined (e.g. as provided by the community graph database 66 and/or user-defined from computing device 48). The resolution thus defines the density of the interconnectedness of the nodes within a community. Each identified community graph is thus a subset of the network graph of nodes and edges (the topic network) defined in block 204 for each community. In one aspect, the community graph further displays both a visual representation of the users in the community (e.g. as nodes) with the community graph and a textual listing of the users in the community (e.g. as provided to display screen). In yet a further aspect, the display of the listing of users in the community is ranked according to degree of influence within the community and/or within all communities for topic T (e.g. as provided to display screen). In accordance with block 208, users U_{T} are then split up into their community graph classifications such as U_{C1}, U_{C2}, . . . U_{Cn}.

At block 209, for each given community (e.g. C₁), the server determines popular characteristic values for pre-defined characteristics (e.g. one or more of: common words and phrases, topics of conversations, common locations, common pictures, common meta data) associated with users (e.g. U_{C1}) within the given community based on their social network data. The selected characteristic (e.g. topic or location) can be user-defined (e.g. via input from the computing device 48) and/or automatically generated (e.g. based on characteristics for other communities within the same topic network, or based on previously used characteristics for the same topic T). At block 210, the server outputs the identified communities (e.g. C₁, C₂, . . . , Cₙ) and the popular characteristics associated with each given community. The identified communities can be output (e.g. via the server for display on the display screen) as a community graph in visual association with the characteristic values for a pre-defined characteristic for each community.

Turning to FIG. 9(b), another example embodiment of computer executable instructions are shown for determining one or more influencers of a given topic. Blocks 301 to 304 correspond to blocks 201 to 204 and need not be reiterated. Following block 304, the server 100 ranks users within the topic network using a first ranking process (block 305). The first ranking process may or may not be the same ranking process used in block 205. The ranking is done to identify which users are the most influential in the given topic network for the given topic.

At block 306, the server identifies and filters out outlier nodes (users U_{O}) within the topic network, where U_{O} is a subset of U_{T}. At block 307, the server adjusts the ranking of the users U_{T}, with the users U_{O} removed, using a second ranking process that is based on the number of posts from a user within a certain time period. For example, the server determines that if a first user has a higher number of posts within the last two months compared to the number of posts of a second user within the same time period, then the first user's original ranking (from block 305) may be increased, while the second user's ranking remains the same or is decreased.

It is recognized that a network graph based on all the users U may be very large. For example, there may be hundreds of millions of users in the set U. Analysing the entire data set related to U may be computationally expensive and time consuming. Therefore, using the above process to find a smaller set of users U_{T} that relate to the topic T reduces the amount of data to be analysed. This decreases the processing time as well. In an example embodiment, near real time results of influencers have been produced when analysing the entire social network platform of Twitter. Using the smaller set of users U_{T} and the data associated with the user U_{T}, a new topic network is computed. The topic network is smaller (i.e. less nodes and less edges) than the social network graph that is inclusive of all users U. Ranking users based on the topic network is much faster than ranking users based on the social network graph inclusive of all users U.

Furthermore, identifying and filtering outlier nodes in the topic network helps to further improve the quality of the results.

At block 309, the server is configured to identify communities (e.g. C₁, C₂, . . . , Cₙ) amongst the users U_{T} with the users U₀ removed (e.g. utilizing a community identification module) in a similar manner as previously described in relation to block 208. At block 310, the server is configured to determine, for each given community (e.g. C₁), popular characteristic values for pre-defined characteristics (e.g. common keywords and phrases, topics of conversations, common locations, common pictures, common meta data) associated with users (e.g. U_{C1}) within the given community (e.g. C₁), based on their social network data in a similar manner as previously described in relation to block 209. At block 311, the server is configured to output the identified communities and the characteristic values for the popular characteristics associated with each given community (e.g. C₁-Cₙ) in a similar manner as block 210 (e.g. via a display screen associated with the server 50 and/or the computing device 48).

Turning to FIG. 10, an example embodiment of computer executable instructions are shown for identifying communities from social network data.

A feature of social network platforms is that users are following (or defining as a friend) another user. As described earlier, other types of relationships or interconnectedness can exist between users as illustrated by a plurality of nodes and edges within a topic network. Within the topic network, influencers can affect different clusters of users to varying degrees. That is, based on the process for identifying communities as described in relation to FIG. 10, the server is configured to identify a plurality of clusters within a single topic network, referred to as communities. Since influence is not uniform across a social network platform, the community identification process defined in relation to FIG. 10 is advantageous as it identifies the degree or depth of influence of each influencer (e.g. by associating with one community over another) across the topic network.

As will be defined in FIG. 10, the server is configured to provide a set of distinct communities (e.g. C1, . . . , Cn), and the top influencer(s) in each of the communities. In yet a preferred aspect, the server is configured to provide an aggregated list of the top influencers across all communities to provide the relative order of all the influencers.

At step 401, the server is configured to obtain topic network graph information from social networking data as described earlier (e.g. FIGS. 9(a) and 9(b)). The topic network visually illustrates relationships among the nodes a set of users (U_{T}) each represented as a node in the topic network graph and connected by edges to indicate a relationship (e.g. friend or follower-followee, or other social media interconnectivity) between two users within the topic network graph. At block 402, the server obtains a pre-defined degree or measure of internal and/or external interconnectedness (e.g. resolution) for use in defining the boundary between communities.

At block 403, the server is configured to calculate scoring for each of the nodes (e.g. influencers) and edges according to the pre-defined degree of interconnectedness (e.g. resolution). That is, in one example, each user handle is assigned a Modularity class identifier (Mod ID) and a PageRank score (defining a degree of influence). In one aspect, the resolution parameter is configured to control the density and the number of communities identified. In a preferred aspect, a default resolution value of 2 which provides 2 to 10 communities is utilized by the server. In yet another aspect, the resolution value is user defined (e.g. via computing device 48) to generate higher or lower granularity of communities as desired for visualization of the community information.

At block 404, the server is configured to define and output distinct community clusters (e.g. C₁, C₂, . . . , Cₙ) thereby partitioning the users U_{T} into U_{C1} . . . U_{Cn} such that each user defined by a node in the network is mapped to a respective community. In one aspect, modularity analysis is used to define the communities such that each community has dense connections (high connectivity) between the cluster of nodes within the community but sparse connections with nodes in different communities (low connectivity). In one aspect, the community detection process steps 403-406 can be implemented utilizing a modularity algorithm and/or a density algorithm (which measures internal connectivity). Furthermore, visualization of the results is implemented utilizing Gephi, an open source graph analysis package, and/or a javascript library in one aspect.

At block 405, the server is configured to define and output top influencer across all communities and/or top influencers within each community and provide relative ordering of all influencers. In one aspect, the top influencers are visually displayed alongside their community when a particular community is selected. In yet a further aspect, at block 405, the server is configured to provide an aggregated list of all the top influencers across all communities to provide the relative order of all the influencers.

At block 406, the server is configured to visually depict and differentiate each community cluster (e.g. by colour coding or other visual identification to differentiate one community from another). In a further aspect, at block 406, the server is configured to provide a set of top influencers in each of the communities visually linked to the respective community. In yet a further aspect, the server at block 406, the server is configured to vary the size of each node of the community graph to correspond to the score of the respective influencer (e.g. score of influence). As output from block 406, the edges from the nodes show connections between each of the users, within their community and across other communities.

Accordingly, the visualization of the communities and the influencers (e.g. the top influencers ranked within each communities and/or a listing of top influencers across all communities) allow an end user (e.g. a user of computing device 48 to visualize the scale and relative significance of each of the influencers in their associated communities.

As described in relation to FIGS. 9(a) and 9(b), in yet a further aspect, the server is configured to determine, for each given community (e.g. C₁) provided by block 403, popular characteristic values for pre-defined characteristics (e.g. common keywords and phrases, topics of conversations, common locations, common images, common meta data) associated with users (e.g. U_{C1}) within the given community (e.g. C₁), based on their social network data. Accordingly, trends or commonalities by examining the pre-defined set of characteristics (e.g. topics of conversation) for users U_{C1} within each community C₁ can be defined. In one aspect, the top listing of characteristic values (e.g. top topics of conversation among all users within each community) is depicted at block 405 and output to the computing device 48 for display in association with each community.

### Target Audience Determination

Turning to FIG. 11, an example embodiment of computer executable instructions are shown for determining a target audience. The process of identifying a target audience (e.g. using look-a-like identification process) may be executed via the look-a-likes module 38. The process of identifying a target audience helps to identify priority nodes. The instructions include obtaining an initial group of users in a social data network. This initial group may be called the sample target users. The server then obtains the identities of friends of the users (501). In the example of Twitter, the identities are called “handles”. Heuristics may then be used to eliminate very generic friends, who are followed by almost everyone on the network (502). From the list of all friends, the server obtains the list of top N most frequently occurring friend user accounts (e.g. the top N friend Twitter handles in the example of Twitter) (503). In a non-limiting example, N is in the range of approximately 10 to 20.

For each friend account identified in the top N, the server obtains his or her list of follower handles.

The follower identities (e.g. or handles) are parsed to filter out identities that follow less than X number of top N friends (505).

The remaining list of identities (e.g. or handles) is the list of look-a-likes, also called users in the target audience (506).

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the server 50, cluster of servers 49, or device 48, any component of or related to the server 50, cluster of servers 49, device 48, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of updating a social network graph, the method comprising:
using at least one client application and graph data retrieved from a database storing the social network graph to determine current activity in the social network;
using the current activity to determine one or more priority nodes in the social network graph to be updated;
obtaining social network updates for each of the one or more priority nodes; and
updating the one or more priority nodes using the social network updates.

2. The method of claim 1, further comprising adding the one or more priority nodes to a queue and updating each priority node upon determining the corresponding social network updates.

3. The method of claim 1, further comprising accessing the database to retrieve the current activity.

4. The method of claim 1, further comprising using at least one social network API to obtain the social network updates.

5. The method of claim 1, further comprising accessing the updated graph for performing at least one social media intelligence operation.

6. The method of claim 1, wherein the updating comprises removing each priority node and re-establishing edges connected to that node based on the social network updates.

7. The method of claim 1, further comprising identifying at least one supernode in the one or more priority nodes.

8. The method of claim 7, further comprising, for each supernode:
translating the supernode into a plurality of node objects;
applying an identifier to each node object; and
applying a predetermined formula to connect node objects by edges determined from the social network updates.

9. The method of claim 8, wherein the predetermined formula utilizes a set of 256 node objects.

10. A non-transitory computer readable medium comprising computer executable instructions for performing the method claim 1.

11. A system comprising one or more servers, the one or more servers comprising a processor and memory, the memory comprising computer executable instructions for:
using at least one client application and graph data retrieved from a database storing the social network graph to determine current activity in the social network;
using the current activity to determine one or more priority nodes in the social network graph to be updated;
obtaining social network updates for each of the one or more priority nodes; and
updating the one or more priority nodes using the social network updates.

12. The system of claim 11 wherein the computer executable instructions further comprise adding the one or more priority nodes to a queue and updating each priority node upon determining the corresponding social network updates.

13. The system of claim 11 wherein the computer executable instructions further comprise accessing the database to retrieve the current activity.

14. The system of claim 11 wherein the computer executable instructions further comprise using at least one social network API to obtain the social network updates.

15. The system of claim 11 wherein the computer executable instructions further comprise accessing the updated graph for performing at least one social media intelligence operation.

16. The system of claim 11 wherein the computer executable instructions further comprise removing each priority node and re-establishing edges connected to that node based on the social network updates.

17. The system of claim 11 wherein the computer executable instructions further comprise identifying at least one supernode in the one or more priority nodes.

18. The system of claim 17 wherein the computer executable instructions further comprise, for each supernode:
translating the supernode into a plurality of node objects;
applying an identifier to each node object; and
applying a predetermined formula to connect node objects by edges determined from the social network updates.

19. The system of claim 18, wherein the predetermined formula utilizes a set of 256 node objects.

20. A computing system for updating a social network graph, the computing system comprising:
a cluster of database servers storing a social network graph distributed across the cluster, the social network graph comprising user accounts represented as nodes connected to each other with edges; and
one or more servers comprising a processor, a memory, and a communication device, the communication device configured to receive and transmit data from the cluster;
the memory comprising computer executable instructions to at least:
access the cluster to obtain current activity associated with the user accounts in the social network graph;
use the current activity to determine one or more priority nodes in the social network graph;
store the one or more priority nodes on a queue within the memory;
access the queue in the memory to identify a given node of the one or more priority nodes and obtain social network updates for the given node via an application programming interface also stored in the memory;
use the social network updates to update the given node and its edge connections; and
send the updated given node and the updated edge connections to the cluster via the communication device.
